(19) United States
(12) Patent Application Publication
(10) Pub. No.: US 2025/0362072 A1
(43) Pub. Date: Nov. 27, 2025

(54) SYSTEMS AND METHODS FOR PREVENTING ICE DEPOSITION ON A GAS VENTING OUTLET

(71) Applicant: FERMI FORWARD DISCOVERY GROUP, LLC, Chicago, IL (US)

(72) Inventor: William H. Scofield, North Aurora, IL (US)

(21) Appl. No.: 19/211,043

(22) Filed: May 16, 2025

Related U.S. Application Data
(60) Provisional application No. 63/650,517, filed on May 22, 2024.

(51) Int. Cl. F25D 21/04

(52) U.S. Cl. CPC F25D 21/04; F25D 2400/02

(57) ABSTRACT

Embodiments disclosed herein are directed to systems and methods for preventing ice deposition on a vent comprising a vacuum jacketed pipe that has an inlet end configured to flow a gas having a gas temperature lower than 228 degrees Kelvin to an outlet end of the vacuum jacketed pipe, a gas venting outlet that includes a vent pipe connected axially to the outlet end of the vacuum jacketed pipe and configured to vent the gas to an atmosphere, and a first heating cable that is spirally wrapped around the vent pipe and configured to prevent ice deposition on the gas venting outlet.

### CROSS REFERENCE TO RELATED PATENT APPLICATION

This patent application claims the priority and benefit, under 35 U.S.C. § 119 (e), of U.S. Provisional Patent Application Ser. No. 63/650,517, filed May 22, 2024, and titled “SYSTEMS AND METHODS FOR PREVENTING ICE DEPOSITION ON A GAS VENTING OUTLET”. U.S. Provisional Application Ser. No. 63/650,517 is incorporated herein by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

The systems and methods relate to cryogenic systems, venting gas from cryogenic systems, and to preventing the deposition of ice on an output vent of a cryogenic system due to the gas cooling the output vent below the dewpoint of the atmosphere surrounding the output vent.

### BACKGROUND

Cryogenic systems may require venting off the vapors of a boiling cryogen that is used to cool a condenser. Such venting may be necessary to prevent overpressure, but most often a cryogen flowing through a condenser is not recirculated, it flows through just once and is vented off.

For example, some cryogenic systems use liquid nitrogen to maintain the temperature of liquid argon at 87 Kelvin. The gas that boils off of the liquid nitrogen may be vented to atmosphere outdoors to prevent asphyxiation hazards indoors. The gas is very cold, well below the freezing point of water, causing water vapor in the atmosphere to freeze and consolidate on the vent. Over a short period of time, usually less than one day, a large ice ball may form on the vent. The rate at which the ice ball forms is related to the humidity in the air and relative temperature of the exhaust, and the flow rate of the cryogen vapor flowing through the vent.

The ice ball may form and grow even during the warmest summer days. This causes 2 major problems. First, the buildup of ice can close off the vent and create an over pressure in the vent line. In addition, the ice ball may be a safety hazard because the ice ball grows and becomes very heavy and may break off and fall to the ground, in some cases 30 feet below, and may injure people or cause damage to property.

The current solution is for the ice ball to be removed by a person using a long pipe to break it up such that it falls to the ground. This is also a safety hazard because it places the person below the heavy falling ice.

As such, there is a need in the art to prevent the formation of such ice balls at vents, as disclosed herein.

### SUMMARY

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure as a prelude to the more detailed description that is presented later.

An aspect of the subject matter described in this disclosure may be implemented by a system. The system may include a vacuum jacketed pipe that has an inlet end configured to flow a gas to an outlet end of the vacuum jacketed pipe, a gas venting outlet that includes a vent pipe connected axially to the outlet end of the vacuum jacketed pipe and configured to vent the gas to an atmosphere, and a first heating cable that is spirally wrapped around the vent pipe and configured to prevent ice deposition on the gas venting outlet.

Yet another aspect of the subject matter described in this disclosure may be implemented in a method. The method may include flowing a gas having a gas temperature lower than 228 degrees Kelvin to an outlet end of a vacuum jacketed pipe, venting the gas to atmosphere via a gas venting outlet that includes a vent pipe connected axially to the outlet end of the vacuum jacketed pipe, and raising an atmospheric temperature at the gas venting outlet above a dewpoint by electrically powering a first heating cable that is spirally wrapped around the vent pipe.

Another aspect of the subject matter described in this disclosure may be implemented by a system. The system may include a piping means for flowing a gas having a gas temperature lower than 228 degrees Kelvin, a venting means for venting the gas to atmosphere, the venting means connected axially to an outlet end of the piping means, and a heating means for raising an atmospheric temperature at the venting means above a dewpoint, the heating means spirally wrapped around the venting means.

In some implementations of the methods and devices, the first heating cable is a first self-regulating heating cable. In some implementations of the methods and devices, preventing ice deposition on the gas venting outlet requires less than 1000 Watts.

In some implementations of the methods and devices, the system includes a second self-regulating heating cable, wherein the second self-regulating heating cable is spirally wrapped around the vacuum jacketed pipe and is located adjacent to the first self-regulating heating cable, and the second self-regulating heating cable is spirally wrapped around the vent pipe and is configured to prevent ice deposition on the gas venting outlet. In some implementations of the methods and devices, the system includes insulation surrounding the first self-regulating heating cable and the second self-regulating heating cable. In some implementations of the methods and devices, the system includes a shroud configured to protect the insulation. In some implementations of the methods and devices, the system includes insulation surrounding the first heating cable. In some implementations of the methods and devices, the system includes a shroud configured to protect the insulation. In some implementations of the methods and devices, the shroud includes a hood configured to reduce an amount of wind driven rain or snow entering the vent pipe.

In some implementations of the methods and devices, preventing ice deposition on the gas venting outlet includes raising an atmospheric temperature at the gas venting outlet above a dewpoint. In some implementations of the methods and devices, the first heating cable is a first self-regulating heating cable that includes two conductors and a conductive core that surrounds the two conductors, the conductive core is configured to increase a distance between the two conductors in response to the conductive core heating up, and the conductive core is configured to decrease the distance between the two conductors in response to the conductive core cooling down. In some implementations of the methods and devices, the first self-regulating heating cable is configured to keep a temperature of the first self-regulating heating cable within a range of 339 degrees Kelvin to 347 degrees Kelvin. In some implementations of the methods and devices, the system includes a power controller configured to prevent ice deposition on the gas venting outlet by providing electric power to the first heating cable. In some implementations of the methods and devices, the system includes a temperature sensor configured to produce a sensor output that indicates a temperature of the first heating cable, wherein the power controller is configured to keep the temperature of the first heating cable within a range of 339 degrees Kelvin to 347 degrees Kelvin.

In some implementations of the methods and devices, a second self-regulating heating cable is spirally wrapped around the vacuum jacketed pipe and is located adjacent to the first self-regulating heating cable, and the second self-regulating heating cable spirally is wrapped around the vent pipe and is configured to prevent ice deposition on the gas venting outlet.

In some implementations of the methods and devices, the heating means is self-regulating and includes two parallel conductors, and the heating means is configured to regulate a temperature of the heating means by increasing a distance between the two parallel conductors in response to the heating means heating up, and decreasing the distance between the two parallel conductors in response to the heating means cooling down.

These and other aspects will become more fully understood upon a review of the detailed description, which follows. Other aspects and features will become apparent to those of ordinary skill in the art, upon reviewing the following description of specific examples in conjunction with the accompanying figures. While features may be discussed relative to certain examples and figures below, any example may include one or more of the advantageous features discussed herein. In other words, while one or more examples may be discussed as having certain advantageous features, one or more of such features may also be used in accordance with the various examples discussed herein. In similar fashion, while the examples may be discussed below as devices, systems, or methods, the examples may be implemented in various devices, systems, and methods.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1A is a high-level conceptual diagram illustrating an example of cold gas flowing through a vacuum jacketed pipe and into a vent pipe that is axially connected to the vacuum jacketed pipe, in accordance with the disclosed embodiments.

FIG. 1B is a high-level conceptual diagram illustrating an example of heating cable wrapped around the vacuum jacketed pipe and the vent pipe illustrated in FIG. 1A, in accordance with the disclosed embodiments.

FIG. 1C is a high-level conceptual diagram illustrating an example of insulation surrounding the heating cable illustrated in FIG. 1B, in accordance with the disclosed embodiments.

FIG. 1D is a high-level conceptual diagram illustrating an example of a shroud surrounding the insulation illustrated in FIG. 1C, in accordance with the disclosed embodiments.

FIG. 2 is a high-level conceptual diagram illustrating an example of a self-regulating heating cable, in accordance with the disclosed embodiments.

FIG. 3 is a high-level conceptual diagram illustrating an example of a self-regulating heating cable that is spirally wrapped around a vacuum jacketed pipe and a vent pipe, in accordance with the disclosed embodiments.

FIG. 4 is a high-level conceptual diagram illustrating an example of heating cable with temperature sensors and a power controller, in accordance with the disclosed embodiments.

FIG. 5 is a high-level conceptual diagram illustrating an example of a heating cable spirally wrapped in multiple layers on a pipe, in accordance with the disclosed embodiments.

FIG. 6 is a high level block diagram illustrating an example of cryogenic gas venting to the atmosphere via a gas venting outlet, in accordance with the disclosed embodiments.

FIG. 7 is a high-level conceptual diagram illustrating an example of a vent pipe that is axially connected to a vacuum jacketed pipe, in accordance with the disclosed embodiments.

FIG. 8 is a high-level flow diagram illustrating an example of a method for preventing ice deposition on a gas venting outlet, in accordance with the disclosed embodiments.

### DETAILED DESCRIPTION

It will be readily understood that the particular values and configurations discussed in the following non-limiting examples can be varied, and are cited merely to illustrate one or more embodiments, and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein. Rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” a used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “In another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations. The principal features can be employed in various embodiments without departing from the scope disclosed herein. Those skilled in the art will recognize, or be able to ascertain, using no more than routine experimentation, numerous equivalents to the specific procedures described herein. Such equivalents are considered to be within the scope of the disclosed embodiments and are covered by the claims.

The use of the word “a” or “an” when used in conjunction with the term “comprising in the claims and/or the specification may mean “one,” but it is also consistent with the meaning of “one or more,” at “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of “having,” such as “have” and “has”), “including” (and any form of “including,” such as “includes” and “include”) or “containing” (and any form of “containing,” such as “contains” and “contain”) are inclusive or open-ended and do not exclude additional, un-recited elements or method steps.

All of the compositions and/or methods disclosed and claimed herein can be made and executed without undue experimentation in light of the present disclosure. While the compositions and methods have been described in terms of preferred embodiments, it will be apparent to those of skill in the art that variations may be applied to the compositions and/or methods and in the steps, or in the sequence of steps, of the method described herein without departing from the concept, spirit, and scope of the disclosed embodiments. All such similar substitutes and modifications apparent to those skilled in the art are deemed to be within the spirit, scope and concept as defined by the appended claims.

Reference throughout this specification to “one example”, “an example”, or similar language means that a particular feature, structure, or characteristic described in connection with the indicated example is included in at least one example. Thus, the phrases “in one example”, “in an example”, and similar language throughout this specification may, but do not necessarily, all refer to the same example.

Venting a cold gas to the atmosphere can cause ice to be deposited on an outlet vent, thereby producing an ice ball that can block the vent and can cause damage or injury by falling onto people or property. One way to prevent the ice ball from forming is to heat the atmosphere to a temperature above the dewpoint near the outlet vent. Cryogenic gas can flow into the inlet end of a vacuum jacketed pipe. A gas venting outlet located at the outlet end of the vacuum jacketed pipe can include heating elements that warm the atmosphere near the gas venting outlet, thereby preventing ice deposition on the gas venting outlet.

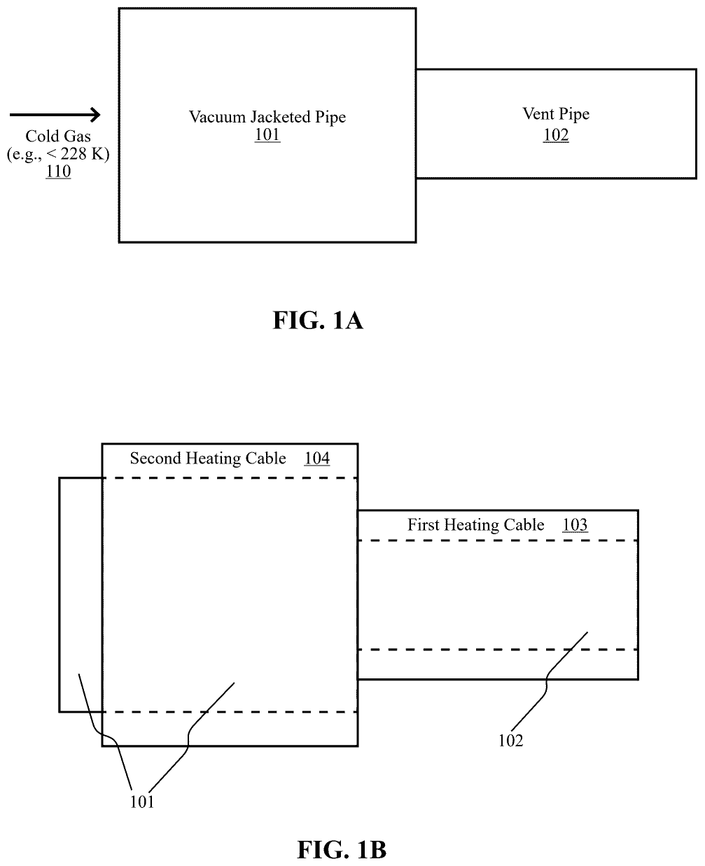

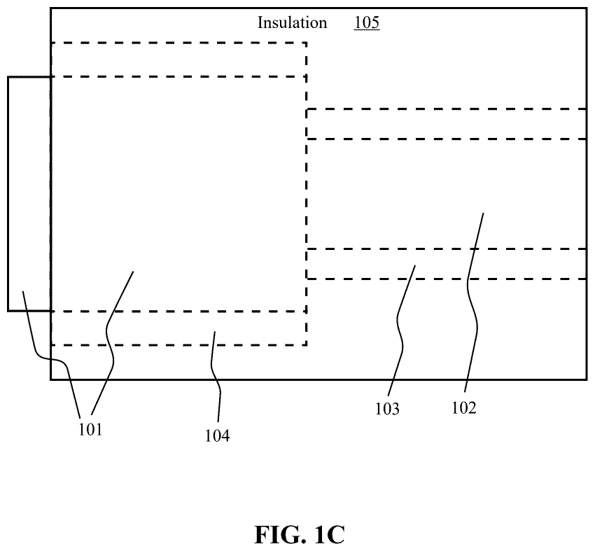

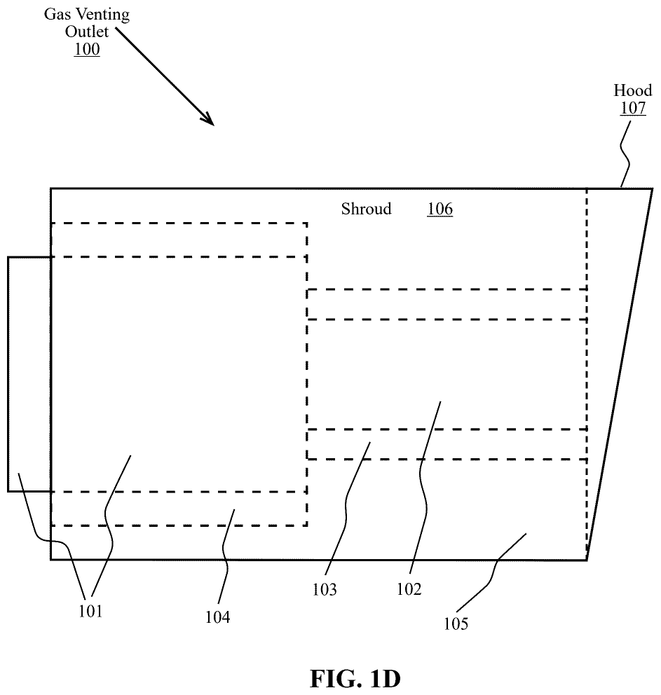

FIG. 1A is a high-level conceptual diagram illustrating an example of cold gas 110 flowing through a vacuum jacketed pipe 101 and into a vent pipe 102 that is axially connected to the vacuum jacketed pipe 101, according to some aspects. The cold gas 110 can have a gas temperature that is less than 228 degrees Kelvin. In an example, liquid nitrogen can be used to cool an apparatus or another gas (e.g., argon) that is used by an apparatus. In such scenarios, the liquid nitrogen can boil at 77.4 degrees Kelvin (−195.8 degrees Centigrade,-320.4 degrees Fahrenheit). The boiling liquid nitrogen produces cryogenic nitrogen gas that flows into the vacuum jacketed pipe. The nitrogen gas can warm as it passes through the vacuum jacketed pipe but may still be cold enough when vented to cause an ice ball to form. The ice ball may form when water vapor in the atmosphere is deposited on a cold surface.

FIG. 1B is a high-level conceptual diagram illustrating an example of heating cable wrapped around the vacuum jacketed pipe and the vent pipe illustrated in FIG. 1A, according to some aspects. A first heating cable 103 is wrapped around the vent pipe 102 and a second heating cable 104 is wrapped around the vacuum jacketed pipe 101. In an example, the first heating cable 103 and the second heating cable 104 are a single heating cable that is wrapped around both the vent pipe and the vacuum jacketed pipe. The second heating cable 104 and the first heating cable 103 are adjacent in FIG. 1B where the vent pipe 102 connects to the vacuum jacketed pipe 101. The dashed lines in FIG. 1B show the locations of the vent pipe and the vacuum jacketed pipe inside the heating cables.

FIG. 1C is a high-level conceptual diagram illustrating an example of insulation 105 surrounding the heating cable illustrated in FIG. 1B, according to some aspects. In an example, the insulation is wrapped around the first heating cable 103 and the second heating cable 104. The dashed lines in FIG. 1C show the locations of the vent pipe, the vacuum jacketed pipe, and the heating cables inside the insulation 105.

FIG. 1D is a high-level conceptual diagram illustrating an example of a shroud 106 surrounding the insulation 105 illustrated in FIG. 1C, according to some aspects. The shroud 106 can be the outer skin of the gas venting outlet 100 and can protect the insulation, heating cables, and other interior elements of the gas venting outlet from damage. In an example, the shroud covers the insulation to thereby protect the insulation. The shroud 106 can have a hood 107 that can be located at the top (vertically) of the gas venting outlet 100. The hood can reduce the amount of wind driven rain or snow entering the vent pipe 102. The gas venting outlet can include the vent pipe 102, the first heating cable 103, the second heating cable 104, the insulation 105, and the shroud 106.

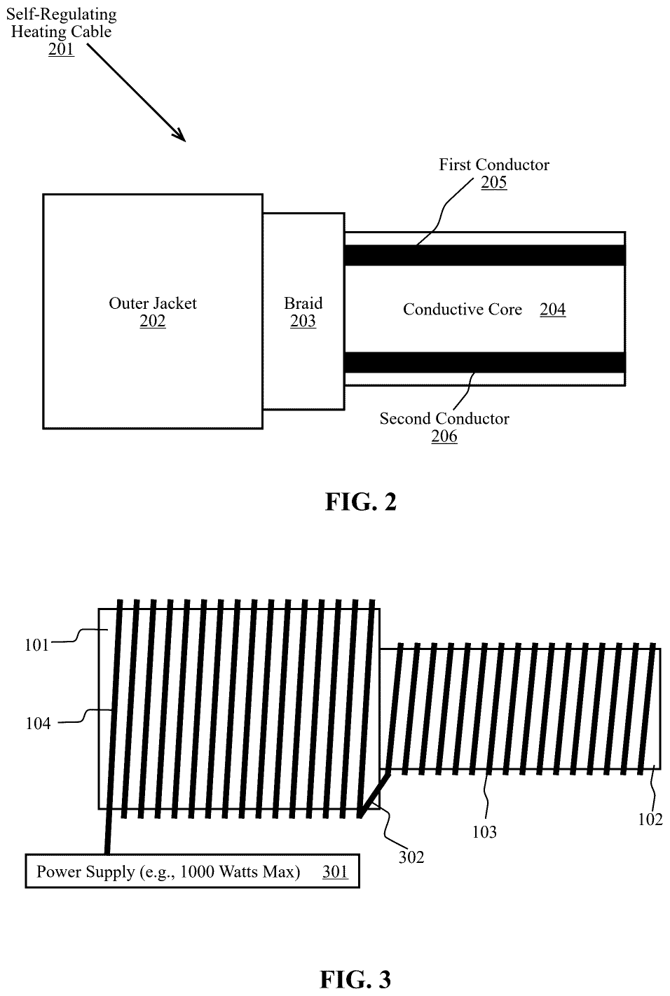

FIG. 2 illustrates a high-level conceptual diagram of an exemplary self-regulating heating cable 201, according to some aspects of the disclosed embodiments. The self-regulating heating cable 201 can have an outer jacket 202 and a braid 203 surrounded by the outer jacket 202.

The self-regulating heating cable 201 can have two conductors and a conductive core 204 inside the braid 203. The two conductors can include a first conductor 205 and a second conductor 206 that are separated by the conductive core 204.

FIG. 2 shows an example in which the first conductor 205 and the second conductor 206 are two parallel conductors. An electric current can flow between the two conductors and through the conductive core 204, thereby generating heat within the conductive core 204. Heating the conductive core can increase the electrical resistance between the two conductors, thereby reducing the amount of heat generated within the conductive core. Cooling the conductive core decreases the electrical resistance between the two conductors, thereby increasing the amount of heat generated within the conductive core. The self-regulating heating cable 201 therefore regulates the temperature of the conductive core.

In an example, the conductive core expands in response to the conductive core heating up and shrinks in response to the conductive core cooling down. The distance between the two conductors increases when the conductive core expands, thereby increasing the electrical resistance of the conductive core. The distance between the two conductors decreases when the conductive core shrinks, thereby decreasing the electrical resistance of the conductive core.

Self-regulating heating cables are available commercially and are specified to keep the cable's temperature within a specified range. The specified range can be a function of the voltage difference between the two conductors. An advantage of self regulating heating cables is that there are no additional control mechanisms required. An example of an additional control mechanism is a power supply that provides electrical power to the heating cable and that governs the amount of power supply based on temperature sensor readings.

FIG. 3 is a high-level conceptual diagram illustrating an example of a self-regulating heating cable that is spirally wrapped around a vacuum jacketed pipe and a vent pipe, according to certain aspects of the disclosed embodiments.

Heating cables are often run parallel to pipes and in contact with the pipes to prevent the pipes from freezing or otherwise being damaged due to low temperatures. However, according to the disclosed embodiments, the aim is not to prevent the pipes from freezing, but rather to raise the ambient temperature enough to prevent formation of an ice ball on the vent. To that end, in the disclosed embodiments, the heating cable can be spirally wrapped around the vent pipe and the vacuum jacketed pipe because the goal is to heat the atmosphere near the gas venting outlet.

A spirally wrapped cable is coiled around the pipe. A power supply 301 is shown providing electric power directly to the second heating cable 104. Electric power passes from the second heating cable 104 to the first heating cable 103 via a jumper 302. The example illustrated in FIG. 3 uses a self-regulating heating cable as the first heating cable 103, the second heating cable 104, and the jumper 302.

In certain embodiments, keeping the heating cables at a temperature of at least 150 degrees Fahrenheit (65.6 degrees Centigrade, 338.75 degrees Kelvin) is sufficient to prevent ice ball formation. As such, in certain embodiments, the temperature of the heating cables can be kept within an operating range of 339 degrees Kelvin to 347 degrees Kelvin. Prototype gas venting outlets have required less than 1000 Watts to maintain that 150 degree Fahrenheit temperature. As such, a power supply rated for 1000 Watts maximum is shown in FIG. 3. In practice, a power supply rated for less than 1000 Watts (e.g., 900 Watts) may be sufficient.

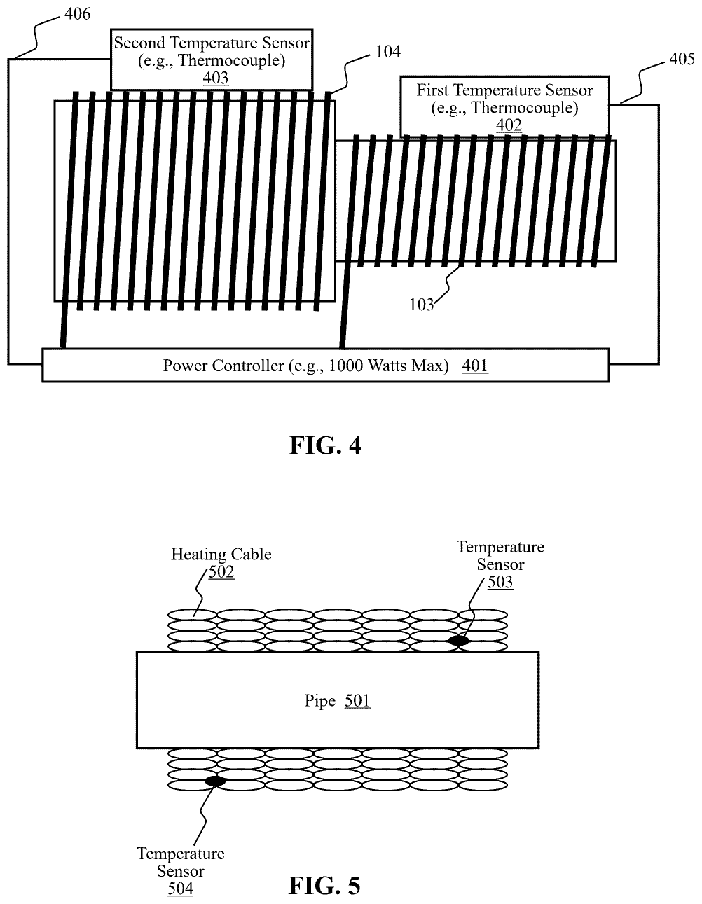

FIG. 4 is a high-level conceptual diagram illustrating an example of heating cable with temperature sensors 402, 403 and a power controller 401, according to some aspects. The example illustrated in FIG. 4 uses separate heating cables as the first heating cable 103 and the second heating cable 104. A first temperature sensor 402 produces a sensor output that indicates the temperature of the first heating cable 103. A second temperature sensor 403 produces a sensor output that indicates the temperature of the second heating cable 104.

The power controller 401 can use the first sensor output 405 (e.g., the sensor output of the first temperature sensor 402) to control the amount of power provided to the first heating cable 103. For example, the desired temperature can be 150 degrees Fahrenheit. As such, the power controller 401 can: a) increase the power to the first heating cable when the first temperature sensor's output indicates a temperature less than the desired temperature; and b) decrease the power to the first heating cable when the first temperature sensor's output indicates a temperature greater than the desired temperature. The power controller 401 can use the second sensor output 406 (e.g., the sensor output of the second temperature sensor 403) to control the amount of power provided to the second heating cable 104.

FIG. 5 is a high-level conceptual diagram illustrating a cut view of an example of a heating cable 502 spirally wrapped in multiple layers on a pipe 501, according to some aspects of the disclosed embodiments. A single layer of heating cable can be insufficient for keeping the heating cable at the desired temperature. Multiple layers can therefore be used as shown in the example illustrated in FIG. 5.

The example uses two temperature sensors to monitor the temperature of the heating cable at two locations. A temperature sensor 503 is located between the first and second heating cable layers. Another temperature sensor 504 is located between the second and third heating cable layers. Multiple temperature sensors can be used for redundancy, for measuring temperature gradients in the heating cable, and for other purposes.

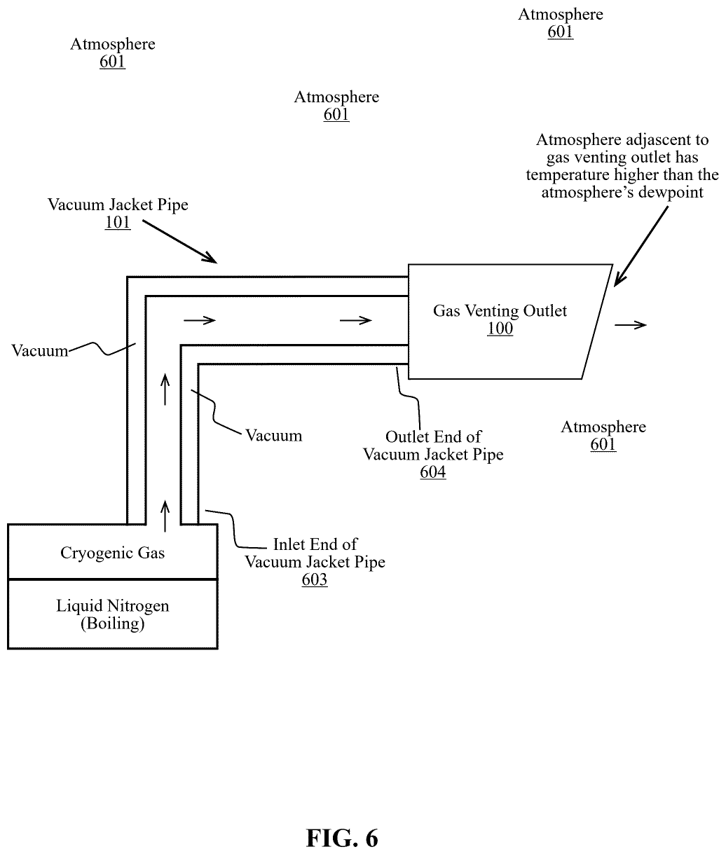

FIG. 6 is a high level block diagram illustrating an example of gas venting to the atmosphere via a gas venting outlet 100, according to some aspects of the disclosed embodiments. Liquid nitrogen can be used to chill equipment or materials (e.g., argon gas that is used in an experiment or process). As such, the liquid nitrogen can boil and thereby produce cryogenic gas. The cryogenic gas can flow into the inlet end 603 of a vacuum jacketed pipe 101. In certain embodiments a vacuum jacketed pipe 101 can comprise a pipe surrounded by vacuum.

Vacuum is an excellent insulator. The gas flows through the vacuum jacketed pipe 101 to a gas venting outlet 100 at the outlet end 604 of the vacuum jacketed pipe 101. The gas venting outlet 100 vents the gas to the atmosphere 601. The atmosphere can have an atmospheric temperature that is less than the dewpoint. The gas venting outlet 100 warms the atmosphere immediately adjacent to the gas venting outlet 100 to an atmospheric temperature higher than the dewpoint of the atmosphere 601, thereby preventing ice deposition on the gas venting outlet 100.

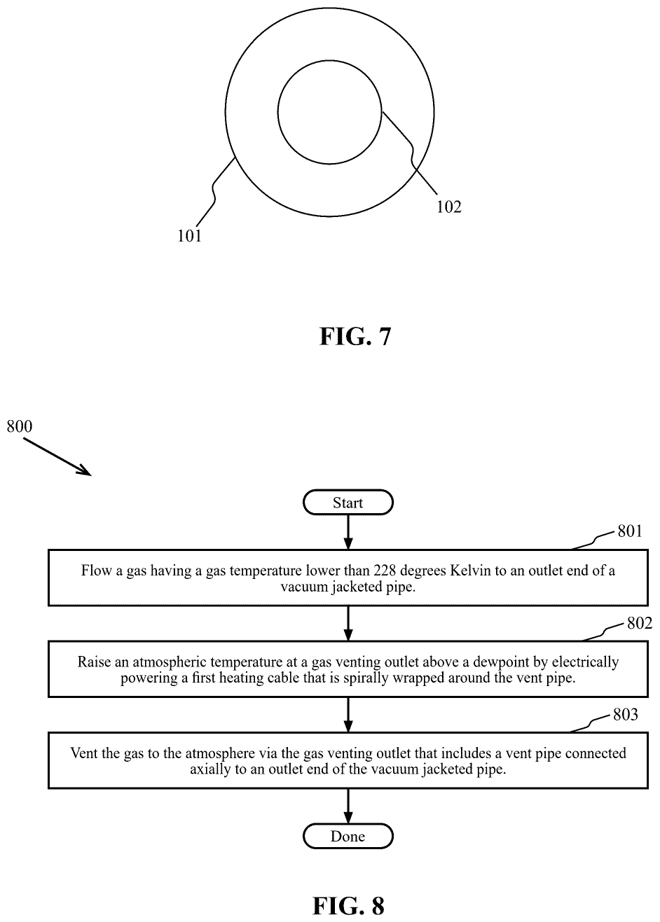

FIG. 7 is a high-level conceptual diagram illustrating an example of a vent pipe 102 that is axially connected to a vacuum jacketed pipe 101, according to some aspects of the disclosed embodiments. The view illustrated in FIG. 7 is looking straight into the end of the vent pipe 102. As can be seen, the center axis of the vent pipe 102 coincides with the center axis of the vacuum jacketed pipe 101. As such, the vent pipe 102 is axially connected to a vacuum jacketed pipe 101.

FIG. 8 is a high-level flow diagram illustrating an example of a method 800 for preventing ice deposition on a gas venting outlet, according to some aspects of the disclosed embodiments. At block 801, a gas having a gas temperature lower than 228 degrees Kelvin flows into an inlet end of a vacuum jacketed pipe. At block 802, an atmospheric temperature at a gas venting outlet is raised above a dewpoint by electrically powering a first heating cable that is spirally wrapped around the vent pipe. At block 803, the gas is vented to the atmosphere via the gas venting outlet that includes a vent pipe connected axially to an outlet end of the vacuum jacketed pipe.

Although the operations of the method(s) herein are shown and described in a particular order, the order of the operations of each method can be altered so that certain operations can be performed in an inverse order or so that certain operations can be performed, at least in part, concurrently with other operations. Instructions or sub-operations of distinct operations can be implemented in an intermittent and/or alternating manner.

Based on the foregoing, it can be appreciated that a number of embodiments are disclosed herein. It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A system comprising:
a vacuum jacketed pipe that has an inlet end configured to flow a gas to an outlet end of the vacuum jacketed pipe;
a gas venting outlet that includes a vent pipe connected axially to the outlet end of the vacuum jacketed pipe and configured to vent the gas to an atmosphere; and
a first heating cable that is spirally wrapped around the vent pipe and configured to prevent ice deposition on the gas venting outlet.

2. The system of claim 1, wherein the first heating cable is a first self-regulating heating cable.

3. The system of claim 2, further including:
a second self-regulating heating cable,
wherein:
the second self-regulating heating cable is spirally wrapped around the vacuum jacketed pipe and is located adjacent to the first self-regulating heating cable; and
the second self-regulating heating cable is spirally wrapped around the vent pipe and is configured to prevent ice deposition on the gas venting outlet.

4. The system of claim 3 further including insulation surrounding the first self-regulating heating cable and the second self-regulating heating cable.

5. The system of claim 4 further including a shroud configured to protect the insulation.

6. The system of claim 1, wherein preventing ice deposition on the gas venting outlet requires less than 1000 Watts.

7. The system of claim 1 further including insulation surrounding the first heating cable.

8. The system of claim 7 further including a shroud configured to protect the insulation.

9. The system of claim 8, wherein the shroud includes a hood configured to reduce an amount of wind driven rain or snow entering the vent pipe.

10. The system of claim 1 wherein preventing ice deposition on the gas venting outlet includes raising an atmospheric temperature at the gas venting outlet above a dewpoint.

11. The system of claim 1 wherein:
the first heating cable is a first self-regulating heating cable that includes two conductors and a conductive core that surrounds the two conductors;
the conductive core is configured to increase a distance between the two conductors in response to the conductive core heating up; and
the conductive core is configured to decrease the distance between the two conductors in response to the conductive core cooling down.

12. The system of claim 11, wherein the first self-regulating heating cable is configured to keep a temperature of the first self-regulating heating cable within a range of 339 degrees Kelvin to 347 degrees Kelvin.

13. The system of claim 1, further including:
a power controller configured to prevent ice deposition on the gas venting outlet by providing electric power to the first heating cable.

14. The system of claim 13, further including:
a temperature sensor configured to produce a sensor output that indicates a temperature of the first heating cable,
wherein the power controller is configured to keep the temperature of the first heating cable within a range of 339 degrees Kelvin to 347 degrees Kelvin.

15. A method comprising:
flowing a gas having a gas temperature lower than 228 degrees Kelvin to an outlet end of a vacuum jacketed pipe;
venting the gas to atmosphere via a gas venting outlet that includes a vent pipe connected axially to the outlet end of the vacuum jacketed pipe; and
raising an atmospheric temperature at the gas venting outlet above a dewpoint by electrically powering a first heating cable that is spirally wrapped around the vent pipe.

16. The method of claim 15, wherein the first heating cable is a first self-regulating heating cable.

17. The method of claim 16, wherein:
a second self-regulating heating cable is spirally wrapped around the vacuum jacketed pipe and is located adjacent to the first self-regulating heating cable; and
the second self-regulating heating cable spirally is wrapped around the vent pipe and is configured to prevent ice deposition on the gas venting outlet.

18. The method of claim 15, wherein preventing ice deposition on the gas venting outlet requires less than 1000 Watts.

19. A system comprising:
a piping means for flowing a gas having a gas temperature lower than 228 degrees Kelvin;
a venting means for venting the gas to atmosphere, the venting means connected axially to an outlet end of the piping means; and
a heating means for raising an atmospheric temperature at the venting means above a dewpoint, the heating means spirally wrapped around the venting means.

20. The system of claim 19 wherein:
the heating means is self-regulating and includes two parallel conductors; and
the heating means is configured to regulate a temperature of the heating means by:
increasing a distance between the two parallel conductors in response to the heating means heating up; and
decreasing the distance between the two parallel conductors in response to the heating means cooling down.
